(19) United States
(12) Patent Application Publication
(10) Pub. No.: US 2022/0255727 A1
(43) Pub. Date: Aug. 11, 2022

(54) LIGHTWEIGHT CRYPTOGRAPHY SYSTEM FOR EMBEDDED REAL TIME SYSTEM

(71) Applicant: One Tech, Inc., Dallas, TX (US)

(72) Inventor: Yandong ZHANG, Plano, TX (US)

(21) Appl. No.: 17/170,602

(22) Filed: Feb. 8, 2021

(51) Int. Cl. H04L 9/06

(52) U.S. Cl. CPC H04L 9/0631; H04L 9/0625

(57) ABSTRACT

A symmetric key lightweight cryptography system for variable length messages is disclosed. The encryption processes of the cryptography system perform a number of rounds of encryption, each round comprising dividing the blocks of the message into a Reference Part and Target Part, performing a self-rotating function on each block of the Target Part based on the Reference Part, performing an self-inverse function on all blocks using a key, and shifting all blocks before the next round of encryption. The decryption processes may decrypt the encrypted message by applying functions that reverses the encryption steps with the same key. The key may be generated by inputting a dynamic random number known to both the encryption and decryption processes to a set of Key Pool comprising a plurality of candidates for the key.

### TECHNICAL FIELD

The present application is related to software cryptography systems. More specifically, the present application is related to lightweight software cryptography systems for variable length messages suitable for embedded real time system.

### BACKGROUND OF THE INVENTION

With the increasing use of embedded real time systems and their need for constant and prevalent communications, the security and privacy of the electronic communications among those systems raise many concerns. Data interception and alteration are real threats to the safety of data which may cause all kinds of problems. Many times, physical protections are not viable choices for those systems. Software-based cryptography has long been recognized as an indispensable protection for achieving data security and privacy by many. The security and robustness of the cryptography as a means to protect data directly rather than relying on physical communication channels depends on the security and robustness of the underlying encryption and decryption algorithms.

### BRIEF DESCRIPTION OF THE DRAWINGS

The advantages and other features of the disclosure will become more apparent to and the invention will be better understood by persons of ordinary skill of the art, with reference to the following description of the examples of the disclosure taken in conjunction with the accompanying drawings, wherein:

FIG. 1 illustrates an encryption process of a data block using the Feistel Cipher algorithm of the prior art;

FIG. 2 is a block diagram illustrating a single-round encryption of an exemplary message;

FIG. 3 a block diagram illustrating a single-round decryption of an exemplary encrypted message;

FIG. 4 is a block diagram illustrating an n-round encryption according to an example of the present application;

FIG. 5 is a block diagram illustrating an n-round decryption according to an example of the present application;

FIGS. 6a-6b illustrate generating of a key y according to an example of the present application;

FIG. 7a is a flowchart illustrating the n-round encryption process according to an example of the present application;

FIG. 7b is a flowchart illustrating the n-round decryption process according to an example of the present application;

FIG. 8 is a block diagram of an example hardware configuration for a mobile device within which the present application may be implemented;

FIG. 9 is a block diagram of an example machine in the form of a computer system within which a set of instructions may be executed for causing the machine to perform any one or more of the processes of the present application; and

FIG. 10 is a block diagram of an example software architecture within which the present application may be implemented.

### DETAILED DESCRIPTION OF THE PREFERRED EMBODIMENTS

Several embodiments of the present application are illustrated by the accompanying drawings and described in detail below. In the figures of the accompanying drawings, elements having the same reference numeral designations represent like elements throughout. The drawings are not to scale, unless otherwise noted. The embodiments are described by way of example, and not by limitation. All terminologies and phraseology used herein are for the purpose of illustrating only and should not be understood as limiting. The phrases such as “including”, “comprising”, “having” and other variations thereof are meant to encompass the items as described and their equivalents without excluding any additional items thereof. The phrases such as “algorithm” and “process” may be used interchangeably in the description.

Many symmetric key cryptography systems have been developed in the prior art. One such system is the block cipher system. A block cipher system uses algorithm which acts on a fixed-length group of bits, which is referred to as a block. The size of the block may vary among systems, such as 128-bit, 192-bit, and so on. The block cipher system uses a so-called substitution technique, in which entire blocks are enciphered using predetermined cipher keys. With such techniques, the enciphered messages become unintelligible ciphertext and can only be understood with a corresponding cipher key. An advantage of the substitution technique is that deciphering process may be easily implemented by a reverse application of the cipher key. In other words, the block cipher uses symmetric cipher key. Further, the block cipher algorithms may run several rounds on the same block to make the enciphered or encrypted message hard to guess.

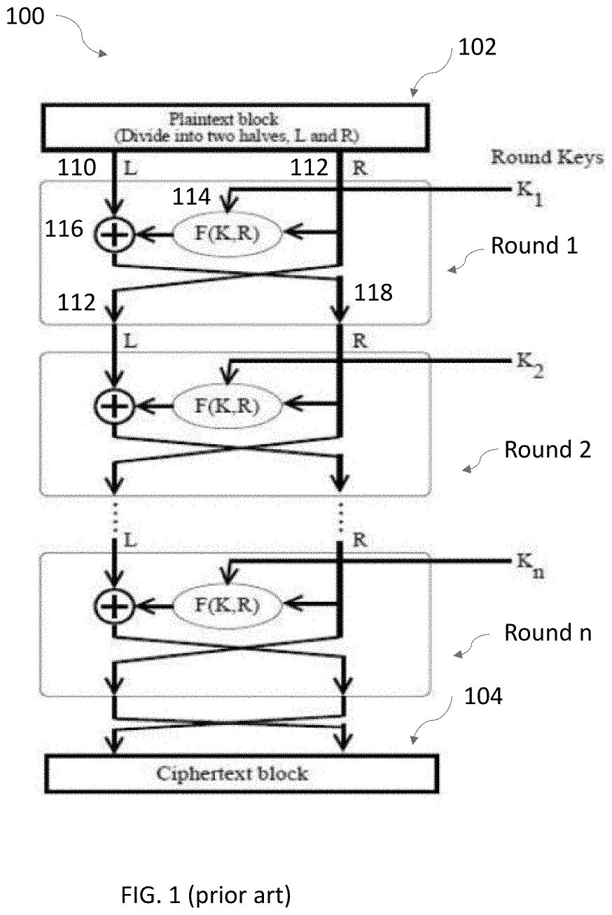

The Feistel Cipher is a well-known design model which provides a design paradigm for many other block cipher algorithms. FIG. 1 illustrates an encryption process of a data block using the Feistel Cipher algorithm. As illustrated in FIG. 1, the Feistel Cipher algorithm 100 takes a block of plain, or unencrypted, data 102 as input and apply a set of mathematical calculations incorporated therein to repeatedly encrypt the block in multiple rounds. Referring to FIG. 1, in Round 1, the Feistel Cipher algorithm 100 divides the input block 102 into two halves that can be denoted as L 110 and R 112, or the left half 110 and the right half 112. As illustrated therein, the right half 112 is applied as an input to ƒ(K,R) 114, wherein ƒ is a mathematical function that takes R 112 and a Round Key K₁ as inputs. The output of the ƒ(K,R) 114 will then be applied to an XOR function 116, together with the left half 110 of the input block 102. The output 118 of the XOR 116 will then be applied to the next round of the algorithm 100 as an updated right half, whereas the right half 112 of the current round will become the updated left half of the next round. After the update, the same steps described above will be repeated in the next round.

As such, the plain block 102 will go through n rounds of the encryption process described above. In each round, a round key K 120 is provided as an input for the function ƒ(K,R) of that round, wherein each key K 120 of the n rounds may be same or different. After n rounds of calculation, the Feistel Cipher algorithm will output the encrypted block 104, which can then be publicly shared or transmitted in unsecured channels. The decryption algorithms use the same set of round keys K to decipher and unwind the blocks in a reverse manner until the original block 102 is recovered.

Despite a past ground-breaking and elegant design, the prior art Feistel Cipher has many disadvantages for lightweight systems, such as real time systems that communicate using variable length messages. For example, the fixed block size of the Feistel Cipher may be cumbersome for such systems. Given a fixed block size, for messages that are longer than it, the algorithm has to run multiple times for both encryption and decryption processes. On the other hand, the block size of the Feistel Cipher is usually in the order of over a hundred of bits, which requires memory allocation and computational power that many lightweight embedded systems find expensive and unnecessary. Also, when the plain message is shorter than the fixed block size, the Feistel Cipher still needs to run on the longer fixed block size, which wastes the resource of the system. As such, for real time system where the block size of the messages varies but may be anticipated to be within a certain range, variable-size cipher would be a better option. Such ciphers conserve system resources, take less CPU time and use less memory.

The present application discloses a lightweight cryptography system that improves over the prior art Feistel Cipher. As in the Feistel Cipher, the cryptography system of the present application is also a symmetric key system. Further, the principle of the substitution technique used in the Feistel Cipher is also embodied the present application. However, the lightweight encryption system of the present application allows for much more efficient encryption and decryption of variable length messages. The plain message may be encrypted and decrypted in blocks as small as 8-bit and all arithmetic operations of the system may be based on eight (8) bits.

The small block size and the arithmetic operation of the present application make the encryption system suitable for a wide range of embedded system devices with different computational capability and memory size. Using 8-bit operations as basic building blocks, the encryption and decryption algorithms may be further optimized in most embedded microprocessors by using their assembly instructions, because the assembly instructions are also based on 8-bit instructions. Such optimizations further save the computational cost of the encryption system and are highly desirable for many embedded systems. In addition, as will be made clear in the present application, the code size of the encryption and decryption algorithm may be set very small, which further saves the system's resources. In the meanwhile, the security and the robustness of the encryption system are guaranteed by similar design philosophy of the Feistel Cipher which supports highly secured cryptography systems and has stood the test of time.

According to an example of the present application, the lightweight cryptography algorithm runs multiple rounds. In each round, the blocks of the message are divided into two parts, namely the Reference Part and the Target Part. The Reference Part is used by the cryptography algorithm to determine the way the Target Part may be or have been encrypted and decrypted. Those single-round encryption and decryption algorithms are repeated multiple times. Between the rounds, the cryptography algorithm will use a block shifting technique to rotate the blocks between the Reference Part and the Target Part, thereby guaranteeing all blocks of the message are encrypted or decrypted after the as a result of the cryptography algorithms.

According to an example of the present application, the Reference Part comprises the first block of the message and the Target Part comprises the remaining blocks. More specifically, the plain original message m comprising n blocks may be denoted with each as m=X[0], X[1], . . . , X[n−1]. As such, the Reference Part may comprise the first, or the leftmost, block of the message m, i.e., X[0] and the Target Part may comprise the remainder of the blocks of the message X[1], . . . , X[n−1]. According to the example, each block of the message m may be 8 bits, although other number of bits, such as 16 bits and 32 bits, etc. may also be supported.

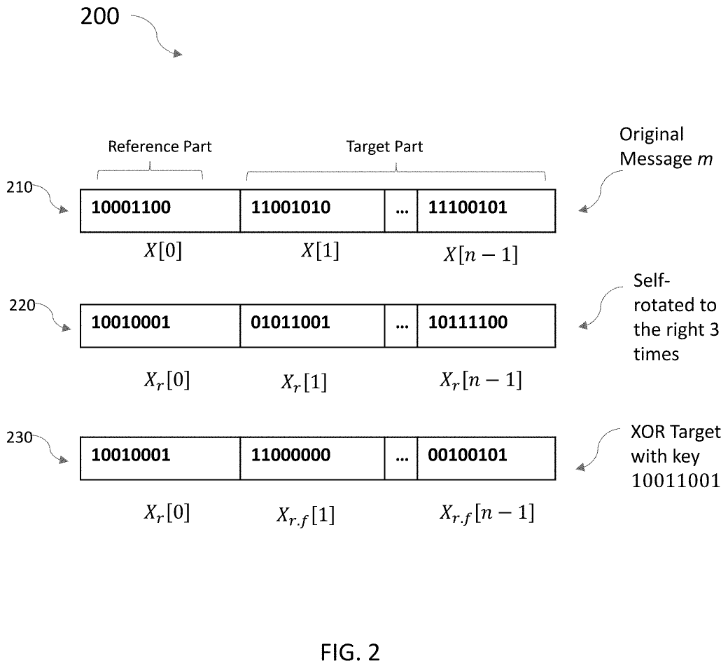

In order to clearly describe the methods of the cryptography system of the present application, single-round encryption and decryption algorithms are described first. FIG. 2 is a block diagram illustrating a single-round encryption algorithm of the exemplary original message m comprising n blocks. Referring to FIG. 2, the n blocks of the message are denoted as X[0], X[1], . . . , X[n−1], where each block has eight (8) bits. In the example illustrated in FIG. 2, the original message is illustrated in 210, where X[0]'s value is 10001100; X[1]'s value is 11001010; and X[n−1]'s value is 11100101. It is noted that all block values are represented in binary forms throughout this application unless otherwise noted. It is further noted that in FIG. 2, the values in the blocks between X[2] and X[n−2] are represented by ellipsis in the drawing and their values are omitted for conciseness. Other blocks represented by the ellipsis in the various figures of the drawings asl similarly represent omitted blocks.

According to an example of the present application, the lightweight cryptography system uses the Reference Part as a basis to decide the operation on the Target Part in the encryption process. In the example illustrated in FIG. 2, the encryption algorithm counts the total number of 1's contained in the Reference Part in its binary form. As shown in FIG. 2, the Reference Part X[0] of 210 has a binary value of 10001100. Therefore, there are total three (3) 1's in X[0]. Accordingly, the encryption algorithm may perform certain arithmetic operation on each block of the Target Part X[1], . . . , X[n−1] based on the number 3, such as self-rotating each block of the Target Part for 3 times as shown in the current example.

Persons skilled in the art understand that self-rotation is a bit-wise operation on a block of data. Usually, computer systems use 8-bit as a basic memory block unit, although operations using another block size are also available. Because 8-bit block size is commonly used in lightweight systems, the examples illustrated in the present application are all based on 8-bit block size.

The idea of self-rotating of a block of data is to shift all bits of information in a single block to one direction and patch the overflowed bits back to the tail of the block sequentially. It can shift to the right (“Shift to the Right Rotation”, or “SRR”) or to the left (“Shift to the Left Rotation”, or “SRL”). For example, for an 8-bit block consisting of 10001010, after one SRR, or SRR₍₁₎, it becomes 01000101. Thereafter, if one SRL or SRL₍₁₎ is applied to the same block, it will be shifted back to the original value of 10001010. It is plain to see that a block that is self-rotated l times, i.e., SRR₍ₗ₎, can be recovered by applying SRL₍ₗ₎ and vice versa, wherein l is the total number of rotations performed. In the examples of the present application, the encryption algorithms always rotate to the right and the decryption algorithms always rotate to the left. Persons skilled in the art understand that that is an arbitrary choice and the opposite directions for the encryption and decryption can be readily adapted. Therefore, such rotation design is within the scope of the present application.

Referring back to the example in FIG. 2, because the Reference Part X[0] in 210 has three 1's, the encryption algorithm will cause each block of the Target Parts of the message to self-rotate to the right 3 times or SRR₍₃₎. The results of the SRR₍₃₎ is illustrated in 220. In particular, the respective blocks of message m after three self-rotation SRR₍₃₎ are as follows: Xᵣ[0]=10010001; Xᵣ[1]=01011001; and Xᵣ[n−1]=10111100. Other blocks not illustrated therein are rotated in the same manner. As seen above, the blocks after the right self-rotation are denoted as Xᵣ[0], Xᵣ[1], . . . , Xᵣ [n−1], in order to indicate that self-rotation has been performed on the blocks. According to an example of the present application, after the self-rotation described above, the encryption algorithm will further perform an arithmetic function on the Target Part Xᵣ[1], . . . , Xᵣ[n−1] that further “hides” the message.

According to an example of the present application, the arithmetic function may be an Exclusive OR, i.e., XOR, function. Persons skilled in the art understand that the XOR function is a logical function operating on logical operands of TRUE and FALSE. When implemented in computers where binary operations are the basis of computing, the computer implemented XOR function commonly take the binary 1 as TRUE and the binary 0 as FALSE and compute a result that corresponds to a logical XOR function of the same inputs. The computer implemented XOR function will return either 1 or 0, also representing TRUE or FALSE, as a result.

In the present example, the blocks are denoted as X_{r.ƒ} after an XOR function is applied in 230. Referring to 230 of FIG. 2, key y is set to be 10011001. As shown in 230, after the XOR function is applied between each Target Part block of 220 and a key y=10011001, then the value of the blocks become X_{r.ƒ} [1]=XOR(01011001, 100110010)=11000000 and X_{r.ƒ}[n−1]=XOR(10111100, 100110010)=00100101. It is noted that according to the example of illustrated in FIG. 2, the XOR function does not apply to the Reference Part. As such, the first block Xᵣ[0]'s notation remains the same in 230. After the XOR function, a single-round encryption of the present application is completed.

Persons skilled in the art understand that the XOR function is a self-inverse function which satisfy the equation x=ƒ(ƒ(x)). When there is more than one input variable, the self-inverse functions satisfy the equation x=ƒ(ƒ(x,y),y). In the context of cryptography, the self-inverse functions are very useful in symmetric key cryptography system. More specifically, in the symmetric cryptography system, there is a key which is both the encryption key and the decryption key of the cryptography system. To illustrate this important characteristic of the XOR function, we denote x as the input message, and y as the key. We further denote z=XOR(x,y), which corresponds to a message encrypted by the XOR function. After receiving the encrypted message z, the decryption algorithm may simply apply another XOR operation on the encrypted message z and key y to recover the original message x. This is tr because according to the self-inversion characteristic of the XOR function, XOR (z,y)=XOR(XOR(x,y), y)=x.

As illustrated in the single-round encryption process of FIG. 2, the present application discloses performing a self-rotation step before the XOR. As described above, a block self-rotated by SRR₍ₗ₎ can be recovered by SRL₍ₗ₎, and vice versa. Therefore, if the encryption process of the present application is noted as SRR₍ₗ₎·ƒ, then the encrypted message may be decrypted by applying ƒ·SRL₍ₗ₎. For convenience, SRR₍ₗ₎ and SRL₍ₗ₎ may both be represented by a subscription r in the drawings to indicate a self-rotation operation on a block. Persons skilled in the art understand that the self-rotation for the encryption and the decryption shall be to the opposite direction. Based on the above observations, the single-round decryption algorithm of the same cryptography system may be designed.

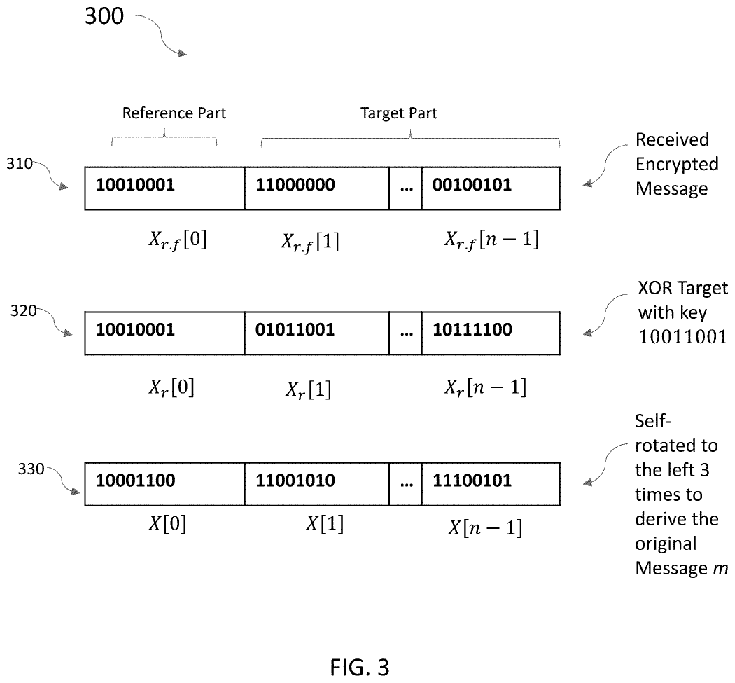

FIG. 3 is a block diagram illustrating a single-round decryption of the message encrypted in FIG. 2. Referring to the decryption process 300 of FIG. 3, the encrypted message Xᵣ[0], X_{r.ƒ} [1], . . . , X_{r.ƒ} [n−1] is received by the decryption process at 310. As illustrated therein, Xᵣ[0]=10010001, X_{r.ƒ} [1]=11000000, and X_{r.ƒ}[n−1]=00100101. These values are the same as the values in 230 of FIG. 2. In step 320 of the decryption process, the XOR function is applied to each block, which also uses the same key y 10011001 that encrypted the message in FIG. 2. As a result of that step, the blocks Xᵣ[0], Xᵣ[1], . . . , Xᵣ[n−1] are recovered at 320. According to FIG. 3, the values of those blocks are: Xᵣ[0]=10010001, Xᵣ[1]=01011001, and Xᵣ[n−1]=101111000. As such, the blocks of Xᵣ[0], Xᵣ[1], . . . , Xᵣ[n−1] at 320 have the same values as the corresponding blocks in step 220 of FIG. 2. This result is anticipated based on the self-inversion characteristics of the XOR function described above.

Thereafter, the decryption process 300 counts the number of 1's in Xᵣ[0] to determine how many times the original message was self-rotated in the encryption process. As illustrated in FIG. 3, Xᵣ[0] 10010001 has three 1's in total. Accordingly, the decryption process 300 then performs three self-rotation to the left three times, i.e., SRL₍₃₎, to recover the original message in 330. As a result, the values of the block in 330 are: X[0]=10001100, X[1]=11001010, and X[n−1]=11100101. These are the same values in step 210 of FIG. 2. In other words, the decryption process 300 decrypted the encrypted the message.

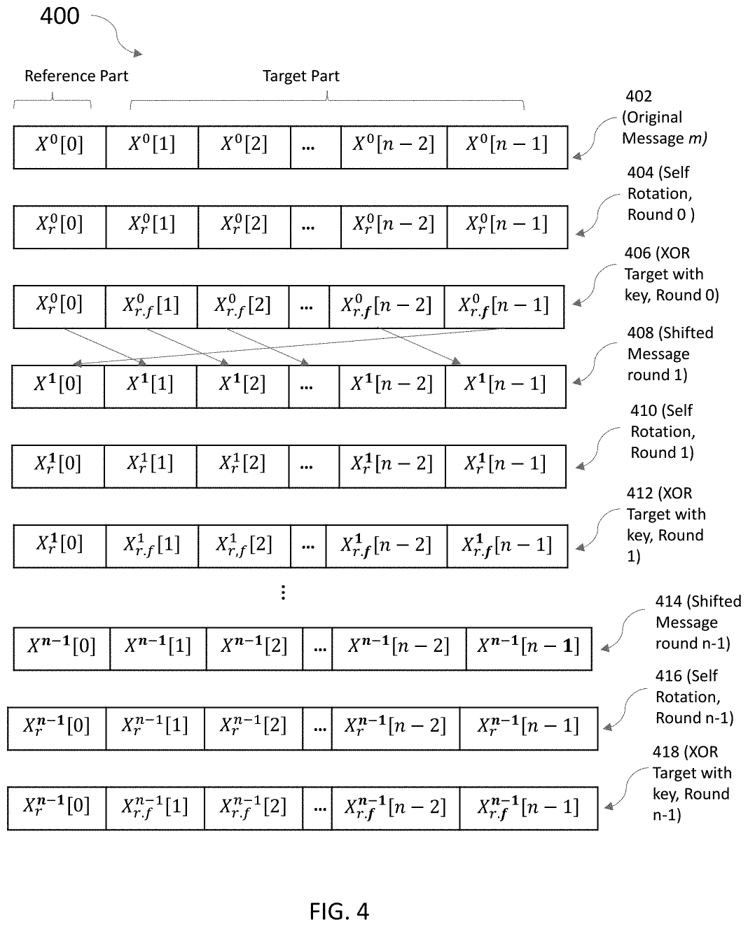

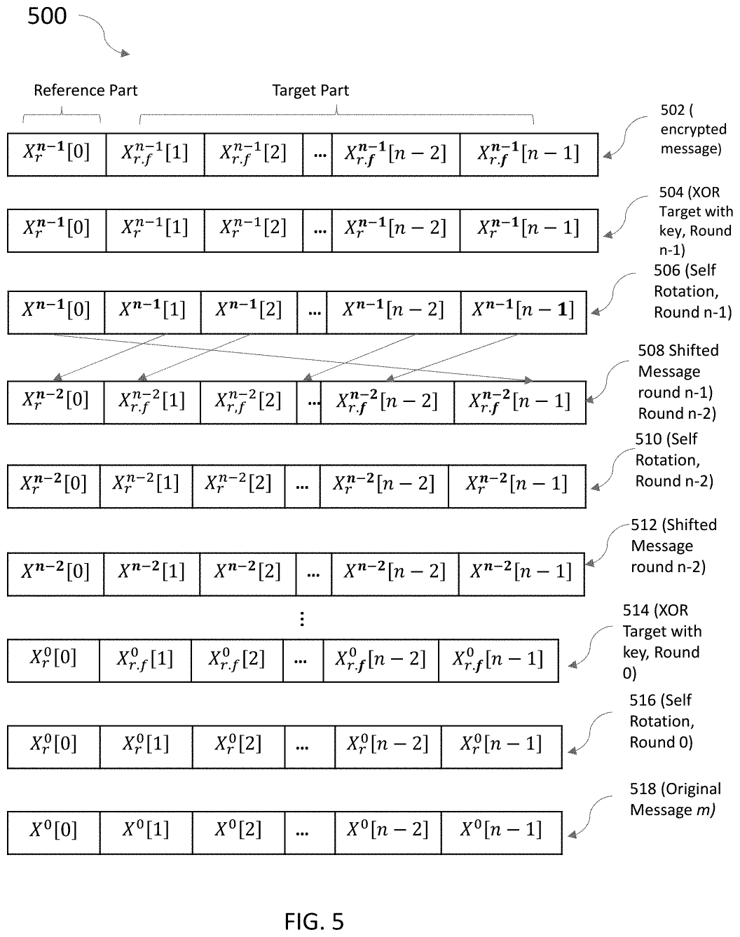

FIGS. 2-3 illustrate the single-round encryption and decryption process of the present application. Similar to the Feistel Cipher, the present application further discloses repeating the single-round encryption multiple times to further add to the security of the cryptography system. In an example, the single-round encryption and decryption processes are repeated n times, or n rounds. According to one example, n is the total number of blocks of the variable length message. FIGS. 4-5 illustrates the encryption and decryption processes of the n-round cryptography algorithms.

In the n-round algorithms, in order to identify the particular round of, the round number is added in superscripts to each block for clarity. It is also noted that the n rounds of the algorithms range from round 0 to round n−1. Now referring to FIG. 4, as shown in 402, in the round 0 of the encryption process 400, the original variable length message m comprises the following n 8-bit blocks: X⁰[0], X⁰[1], X⁰[2], . . . , X⁰[n−2], X⁰[n−1]. As illustrated therein, the leftmost block in each step is the Reference Part and the rest of the blocks are the Target Part. In step 404, the encryption algorithm performs self-rotation of the Target Part X⁰[1], X⁰[2], . . . , X⁰[n−2], X⁰[n−1] based on the number of 1's in the Reference Part X⁰[0] in step 404. Those self-rotated blocks are represented as Xᵣ⁰[0], Xᵣ⁰[1], Xᵣ⁰[2], . . . , Xᵣ⁰[n−2], Xᵣ⁰[n−1] therein. I Step 406, and XOR function is performed between the key y (not shown) and each of the blocks in the Target Part. Those blocks are represented as Xᵣ⁰[0], X_{r,ƒ}⁰[1], X_{r.ƒ}⁰[2], . . . , X_{r.ƒ}⁰[n−2], X_{r.ƒ}⁰[n−1] in 406. Persons skilled in the art understand that steps 402-406 are essentially the same steps illustrated in the single-round encryption illustrated in FIG. 2.

In the n-round encryption process 400, however, after the single-round encryption is completed, the blocks of the entire message will be shifting to a direction similar to the self-rotation of a single block. That is, each of the n blocks will be shifted to one direction. The block at one end of the n blocks to which direction the blocks are shifted will be added at the other end of the blocks and occupies the block that has been “emptied” because all blocks have been shifted up. After the shifting, the new order of the blocks is renumbered from 0 to n−1 based on their shifted positions. Thereafter, another single-round encryption as illustrated in FIG. 2 can be performed based on the new positions of the blocks. In an example of the present application, the entire message is shifted up, i.e., left or right, for one block.

In the encryption process 400 of FIG. 4, as illustrated in 406 and 408, Xᵣ⁰[0] in 406 is shifted one block to the right to X¹[1] in 408. Similarly, X_{r.ƒ}⁰[1] in 406 is also shifted one block to the right to X¹[2] in 408 and so on. The block X_{r.ƒ}⁰[n−1] which is at the right-most end of in 406 is added back to the first block in 408 to become X¹[0]. As indicated above, the previous block content of Xᵣ⁰[0] has been shifted up to X¹[1]. Therefore, all blocks from 406 are preserved in 408. However, after the shifting, the contents of the blocks are re-shuffled. As illustrated in FIG. 4, the next round of encryption will be based on the new order.

Steps 408-412 illustrates the second round of the encryption, which includes the exact same steps of a single-round encryption shown in 402-406. Thereafter, another block shifting process as illustrated in 408 will be performed and the encryption will continue to the third round of the encryption thereafter and so on. The single-round encryption and block shifting will be performed in turn until the n^{th} round is r completed as shown in 414-418 of FIG. 4.

As illustrated in 418 of FIG. 4, the final encrypted message of the n-round encryption process is Xᵣⁿ⁻¹[0], X_{r.ƒ}ⁿ⁻¹[1], . . . , X_{r.ƒ}ⁿ⁻¹[n−2], X_{r.ƒ}ⁿ⁻¹[n−1]. This encrypted message may be transmitted via unsecured communication channels. To decrypt the message, it is observed that the block shifting between each round of the encryption is similar to the self-rotation functions SRL₍ₗ₎ and SRR₍ₗ₎. That is, a right block shift of the message, or RBS, may be reversed by a corresponding left block shift, or LBS, and vice versa. As such, based on the same reasoning and with the similar notations established in connection with the single-round encryption and decryption of the present application, persons skilled in the art understand the n-round encryption using SRR₍ₗ₎.ƒ.RBS may be decrypted with n-round decryption of LBS.ƒ.SRL₍ₗ₎.

FIG. 5 illustrates the decryption process of the n-round algorithm. Referring to the n-round decryption process 500 of FIG. 5, the encrypted message Xᵣⁿ⁻¹[0], X_{r.ƒ}ⁿ⁻¹[1], . . . , X_{r.ƒ}ⁿ⁻¹[n−2], X_{r.ƒ}ⁿ⁻¹[n−1] is received by the decryption process at 502. In 504, each block has performed an XOR with the key y to recover the rotated blocks Xᵣⁿ⁻¹[0], Xᵣⁿ⁻¹[1], . . . , Xᵣⁿ⁻¹, Xᵣⁿ⁻¹[n−1]. In 506, each block will self-rotate to the opposite direction of the self-rotation performed during the encryption process by counting the number of 1's in the Reference Part Xᵣⁿ⁻¹[0]. As such the un-rotated blocks Xⁿ⁻¹[0], Xⁿ⁻¹[1], . . . , Xⁿ⁻¹[n−2], Xⁿ⁻¹[n−1] are recovered in 506. Steps 502-506 are the same steps illustrated in the single-round decryption illustrated in FIG. 3.

In 508, the decryption process will perform a block shift to the opposite direction of the encryption process. In the example illustrates in FIG. 4, the encryption process performs right block shift. As such, the decryption process in FIG. 5 will perform a left shift in 508. More specifically, the block Xⁿ⁻¹[n−1] is shifted to X_{r.ƒ}ⁿ⁻²[n−2]. Similarly, the block Xⁿ⁻¹[n−2] is shifted to X_{r.ƒ}ⁿ⁻²[n−3] and so on. And the left-most block Xⁿ⁻¹[0] in 506 is shifted to the right-most end of the block X_{r.ƒ}ⁿ⁻²[n−1] to patch the “emptied” block previously occupied by Xⁿ⁻¹[n−1]. Thereafter, the same single-round decryption as illustrated in FIG. 3 will be repeated for Round n−2. The block shifting and the single-round decryption will be repeated for all the rounds until step 518, after which the original message X⁰[1], X⁰[2], . . . , X⁰[n−2], X⁰[n−1] is recovered.

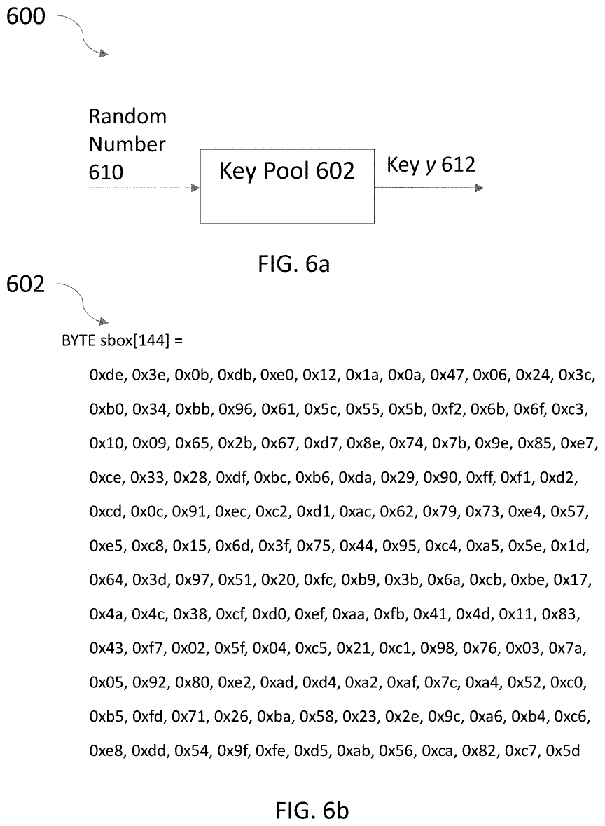

As mentioned above, the present application discloses a symmetric key cryptography design. That is, the encryption process and the decryption process use the same key. Persons skilled in the art understand that the security of the key y is critical to the security of the system. Securely ascertaining the symmetric key y by the encryption algorithm and the decryption algorithm is a critical issue of the lightweight cryptography system of the present application. According to an example illustrated in FIG. 6a-6b, the key y may be generated using a semi-dynamic method. That is, the key y may be derived using a dynamic random number that is generated in real time and a static random number that is part of the algorithms.

Referring to FIG. 6a, in the key generation process 600, a dynamic random number 610 is applied to a KEY POOL 602 to generate the key y 612. The same key generation process is implemented in both the encryption algorithm and the decryption algorithm. More specifically, the dynamic random number 610 must be accessible by both the encryption and decryption ends of the cryptography system. According to an example of the present application, the random number 610 may be generated using a VPN program. Persons skilled in the art understand that the VPN generated random number 610 may be securely shared between the encryption and decryption ends.

Then using the random number 610, both the encryption process and the decryption process use a same KEY POOL 602 to generate the key y. FIG. 6b illustrates a KEY POOL 602 which contains the candidates or seeds for key y. Referring to FIG. 6b, the KEY POOL 602 may have a fixed set of random numbers. In FIG. 6b 144 random numbers represented in hexadecimal format are illustrated. According to one example of the present application, the random number 610 may serve as an input to a mapping function to the entire KEY POOL 602. The mapping function will choose one of the numbers in KEY POOL 602 as a key or a seed for a key. According to the example of the present application, the data in KEY POOL 602 may be built-in data the encryption and decryption programs. As such, when the same random number 610 is received by both ends of the cryptography system, the encryption and decryption algorithms will be able to compute the key y that are identical to each other,

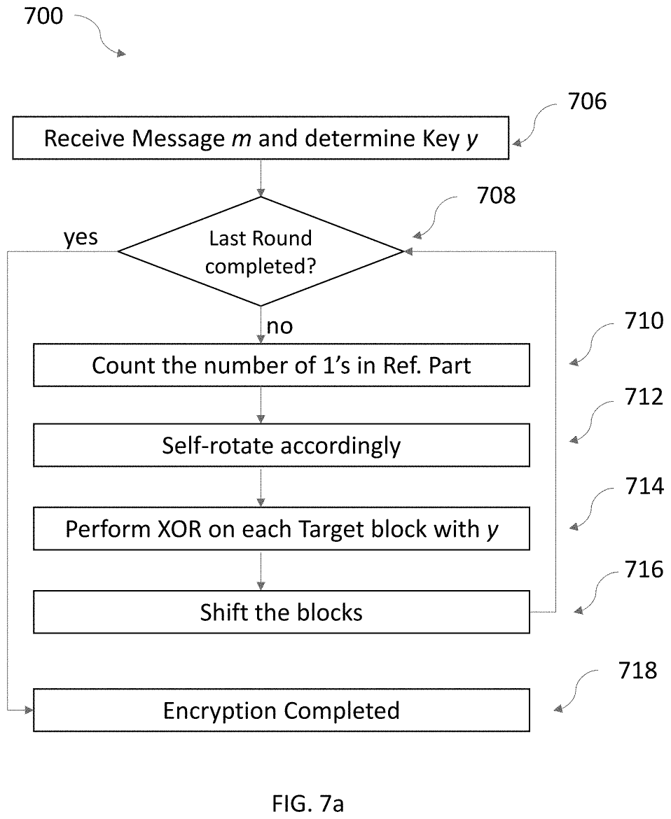

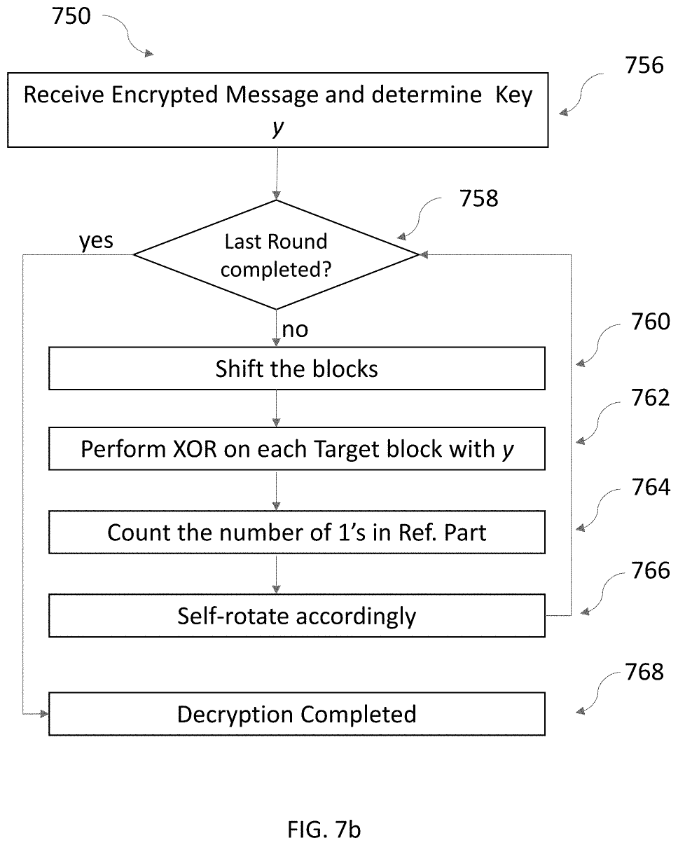

FIGS. 7a-7b are flowcharts illustrating the n-round encryption and decryption processes, respectively. As the encryption and decryption processes have been described in great detail above, the flowcharts in FIGS. 7a-7b incorporates the relevant descriptions in connection with the following descriptions. If any description in connection with FIGS. 7a-7b is construed as in consistent with FIGS. 2-6, the descriptions with respect to FIGS. 2-6 controls.

Referring to FIG. 7a, the encryption process 700 receives a message m and determines key y in step 706. In step 708, the encryption algorithm determines if the last round of the n-round encryption has been completed. If not, the encryption process will divide the blocks into Reference Part and Target Part and determine the number of 1's in the Reference Part in step 710. In 712, the encryption algorithm will self-rotate the blocks accordingly. In 714, the encryption algorithm will perform an XOR function on each target block with the key y. Thereafter, the algorithm will do a shifting the blocks in 716 as described in connection with FIG. 4 and throughout the application. After the last round is completed, the encryption process 700 will terminate in 718.

FIG. 7b illustrates the n-round decryption process. Referring to FIG. 7b, the decryption process 750 receives the encrypted message and determines the key y in 756. In Step 758, the decryption algorithm determines if the last round of the n-round decryption has been completed. If not, the decryption process will self-rotate the blocks of all blocks as described in connection with FIG. 5. In 762, the decryption algorithm will perform an XOR function on each target block with key y. Thereafter, the algorithm will count the number of 1's in the Reference Part of the blocks in step 764. In 766, the decryption process will do self-rotation on all of the Target blocks to the opposite direction of the encryption process as described in connection with FIG. 5 and throughout the application. After the last round is completed, the decryption process 750 will terminate in 768.

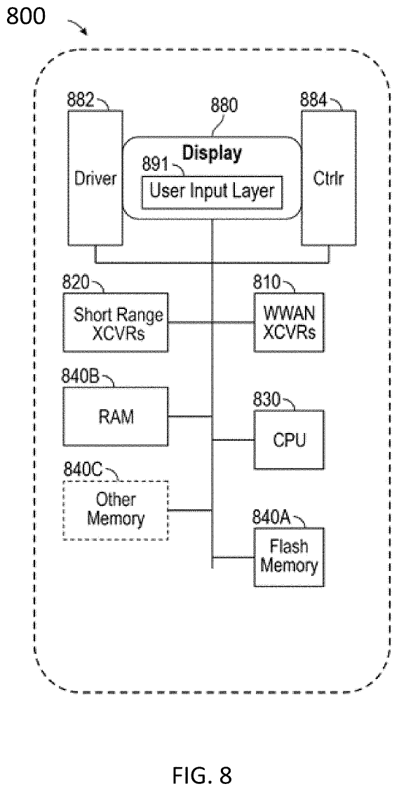

FIG. 8 is a high-level functional block diagram of an example device 800 on which the cryptography algorithms may be implemented. Device 890 includes a flash memory 840A which includes programming to perform all or a subset of the functions described herein. As shown in FIG. 8, the device 890 may include at least one digital transceiver (XCVR) 810, shown as WWAN XCVRs, for digital wireless communications via a wide area wireless mobile communication network. The device 890 also includes additional digital or analog transceivers, such as short range XCVRs 820 for short-range network communication, such as via NFC, VLC, DECT, ZigBee, Bluetooth™, or WiFi. For example, short range XCVRs 820 may take the form of any available two-way wireless local area network (WLAN) transceiver of a type that is compatible with one or more standard protocols of communication implemented in wireless local area networks, such as one of the Wi-Fi standards under IEEE 802.11.

To generate location coordinates for positioning of the device 890, the device 890 may include a global positioning system (GPS) receiver. Alternatively, or additionally the device 890 can utilize either or both the short range XCVRs 820 and WWAN XCVRs 810 for generating location coordinates for positioning. For example, cellular network, WiFi, or Bluetooth™ based positioning systems can generate very accurate location coordinates, particularly when used in combination. Such location coordinates can be transmitted to the eyewear device over one or more network connections via XCVRs 810, 820.

The transceivers 810, 820 (network communication interface) conforms to one or more of the various digital wireless communication standards utilized by modern mobile networks. Examples of WWAN transceivers 810 include (but are not limited to) transceivers configured to operate in accordance with Code Division Multiple Access (CDMA) and 3rd Generation Partnership Project (3GPP) network technologies including, for example and without limitation, 3GPP type 2 (or 3GPP2) and LTE, at times referred to as “4G.” For example, the transceivers 810, 820 provide two-way wireless communication of information including digitized audio signals, still image and video signals, web page information for display as well as web related inputs, and various types of mobile message communications to/from the device 890.

The device 890 further includes a microprocessor, shown as CPU 830, sometimes referred to herein as the host controller. A processor is a circuit having elements structured and arranged to perform one or more processing functions, typically various data processing functions. Although discrete logic components could be used, the examples utilize components forming a programmable CPU. A microprocessor for example includes one or more integrated circuit (IC) chips incorporating the electronic elements to perform the functions of the CPU. The processor 830, for example, may be based on any known or available microprocessor architecture, such as a Reduced Instruction Set Computing (RISC) using an ARM architecture, as commonly used today in devices and other portable electronic devices. Of course, other processor circuitry may be used to form the CPU 830 or processor hardware in smartphone, laptop computer, and tablet.

The microprocessor 830 serves as a programmable host controller for the device 890 by configuring the device 890 to perform various operations, for example, in accordance with instructions or programming executable by processor 830. For example, such operations may include various general operations of the device. Although a processor may be configured by use of hardwired logic, typical processors in devices are general processing circuits configured by execution of programming.

The device 890 includes a memory or storage device system, for storing data and programming In the example, the memory system may include a flash memory 840A and a random access memory (RAM) 840B. The RAM 840B serves as short term storage for instructions and data being handled by the processor 830, e.g., as a working data processing memory. The flash memory 840A typically provides longer term storage.

Hence, in the example of device 890, the flash memory 840A is used to store programming or instructions for execution by the processor 830. Depending on the type of device, the device 890 stores and runs a mobile operating system through which specific applications. Applications may be a native application, a hybrid application, or a web application (e.g., a dynamic web page executed by a web browser) that runs on device 890. Examples of mobile operating systems include Google Android, Apple iOS (I-Phone or iPad devices), Windows Mobile, Amazon Fire OS, RIM BlackBerry operating system, or the like.

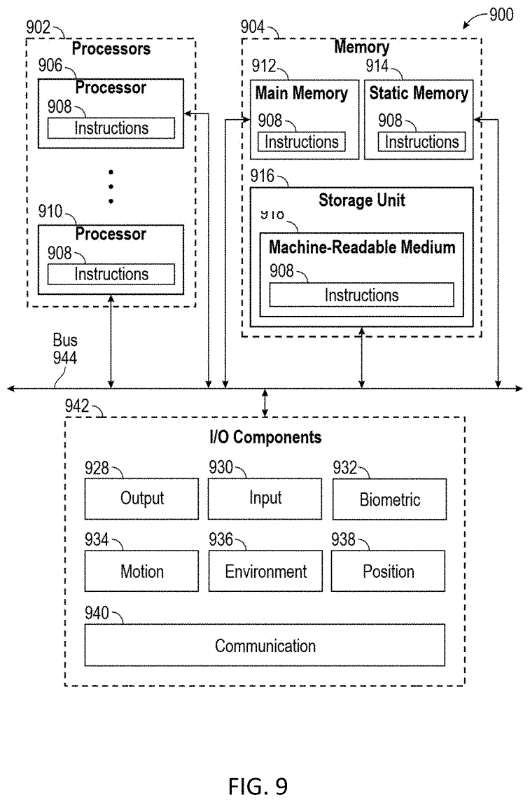

FIG. 9 is a diagrammatic representation of a machine 900 within which instructions 908 (e.g., software, a program, an application, an applet, an app, or other executable code) for causing the machine 900 to perform any one or more of the methodologies discussed herein may be executed. For example, the instructions 908 may cause the machine 900 to execute any one or more of the methods described herein. The instructions 908 transform the general, non-programmed machine 900 into a particular machine 900 programmed to carry out the described and illustrated functions in the manner described. The machine 900 may operate as a standalone device or may be coupled (e.g., networked) to other machines. In a networked deployment, the machine 900 may operate in the capacity of a server machine or a client machine in a server-client network environment, or as a peer machine in a peer-to-peer (or distributed) network environment.

The machine 900 may comprise, but not be limited to, a server computer, a client computer, a personal computer (PC), a tablet computer, a laptop computer, a netbook, a set-top box (STB), a PDA, an entertainment media system, a cellular telephone, a smart phone, a device, a wearable device (e.g., a smart watch), a smart home device (e.g., a smart appliance), other smart devices, a web appliance, a network router, a network switch, a network bridge, or any machine capable of executing the instructions 908, sequentially or otherwise, that specify actions to be taken by the machine 900. Further, while only a single machine 900 is illustrated, the term “machine” shall also be taken to include a collection of machines that individually or jointly execute the instructions 908 to perform any one or more of the methodologies discussed herein.

The machine 900 may include processors 902, memory 904, and I/O components 942, which may be configured to communicate with each other via a bus 944. In an example, the processors 902 (e.g., a Central Processing Unit (CPU), a Reduced Instruction Set Computing (RISC) processor, a Complex Instruction Set Computing (CISC) processor, a Graphics Processing Unit (GPU), a Digital Signal Processor (DSP), an ASIC, a Radio-Frequency Integrated Circuit (RFIC), another processor, or any suitable combination thereof) may include, for example, a processor 906 and a processor 910 that execute the instructions 908. The term “processor” is intended to include multi-core processors that may comprise two or more independent processors (sometimes referred to as “cores”) that may execute instructions contemporaneously. Although FIG. 9 shows multiple processors 902, the machine 900 may include a single processor with a single core, a single processor with multiple cores (e.g., a multi-core processor), multiple processors with a single core, multiple processors with multiples cores, or any combination thereof.

The memory 904 includes a main memory 912, a static memory 914, and a storage unit 916, both accessible to the processors 902 via the bus 944. The main memory 904, the static memory 914, and storage unit 916 store the instructions 908 embodying any one or more of the methodologies or functions described herein. The instructions 908 may also reside, completely or partially, within the main memory 912, within the static memory 914, within machine-readable medium 918 (e.g., a non-transitory machine-readable storage medium) within the storage unit 916, within at least one of the processors 902 (e.g., within the processor's cache memory), or any suitable combination thereof, during execution thereof by the machine 900.

Furthermore, the machine-readable medium 918 is non-transitory (in other words, not having any transitory signals) in that it does not embody a propagating signal. However, labeling the machine-readable medium 918 “non-transitory” should not be construed to mean that the medium is incapable of movement; the medium should be considered as being transportable from one physical location to another. Additionally, since the machine-readable medium 918 is tangible, the medium may be a machine-readable device.

The I/O components 942 may include a wide variety of components to receive input, provide output, produce output, transmit information, exchange information, capture measurements, and so on. The specific I/O components 942 that are included in a particular machine will depend on the type of machine. For example, portable machines such as mobile phones may include a touch input device or other such input mechanisms, while a headless server machine will likely not include such a touch input device. It will be appreciated that the I/O components 942 may include many other components that are not shown in FIG. 9. In various examples, the I/O components 942 may include output components 928 and input components 930. The output components 928 may include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 930 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location, force of touches or touch gestures, or other tactile input components), audio input components (e.g., a microphone), and the like.

In further examples, the I/O components 942 may include biometric components 932, motion components 934, environmental components 936, or position components 938, among a wide array of other components. For example, the biometric components 932 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 934 include acceleration sensor components (e.g., accelerometer), gravitation sensor components, rotation sensor components (e.g., gyroscope), and so forth. The environmental components 936 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment. The position components 938 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 942 further include communication components 940 operable to couple the machine 900 to a network 920 or devices 922 via a coupling 924 and a coupling 926, respectively. For example, the communication components 940 may include a network interface component or another suitable device to interface with the network 920. In further examples, the communication components 940 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 922 may be another machine or any of a wide variety of peripheral devices (e.g., a peripheral device coupled via a USB).

Moreover, the communication components 940 may detect identifiers or include components operable to detect identifiers. For example, the communication components 940 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 940, such as location via Internet Protocol (IP) geolocation, location via Wi-Fi® signal triangulation, location via detecting an NFC beacon signal that may indicate a particular location, and so forth.

The various memories (e.g., memory 904, main memory 912, static memory 914, memory of the processors 902), storage unit 916 may store one or more sets of instructions and data structures (e.g., software) embodying or used by any one or more of the methodologies or functions described herein. These instructions (e.g., the instructions 908), when executed by processors 902, cause various operations to implement the disclosed examples.

The instructions 908 may be transmitted or received over the network 920, using a transmission medium, via a network interface device (e.g., a network interface component included in the communication components 940) and using any one of a number of well-known transfer protocols (e.g., hypertext transfer protocol (HTTP)). Similarly, the instructions 908 may be transmitted or received using a transmission medium via the coupling 926 (e.g., a peer-to-peer coupling) to the devices 922.

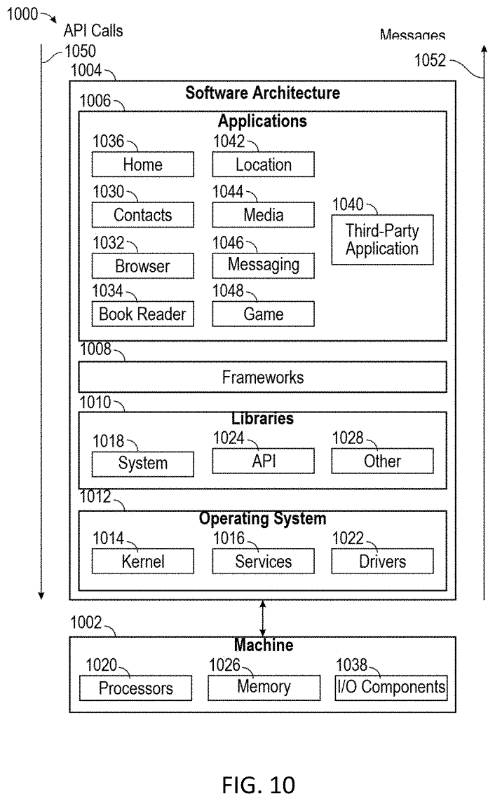

FIG. 10 is a block diagram 1000 illustrating a software architecture 1004, which can be installed on any one or more of the devices described herein. The software architecture 1004 is supported by hardware such as a machine 1002 that includes processors 1020, memory 1026, and I/O components 1038. In this example, the software architecture 1004 can be conceptualized as a stack of layers, where each layer provides a particular functionality. The software architecture 1004 includes layers such as an operating system 1012, libraries 1010, frameworks 1008, and applications 1006. Operationally, the applications 1006 invoke API calls 1050 through the software stack and receive messages 1052 in response to the API calls 1050.

The operating system 1012 manages hardware resources and provides common services. The operating system 1012 includes, for example, a kernel 1014, services 1016, and drivers 1022. The kernel 1014 acts as an abstraction layer between the hardware and the other software layers. For example, the kernel 1014 provides memory management, processor management (e.g., scheduling), component management, networking, and security settings, among other functionality. The services 1016 can provide other common services for the other software layers. The drivers 1022 are responsible for controlling or interfacing with the underlying hardware. For instance, the drivers 1022 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth.

The libraries 1010 provide a low-level common infrastructure used by the applications 1006. The libraries 1010 can include system libraries 1018 (e.g., C standard library) that provide functions such as memory allocation functions, string manipulation functions, mathematic functions, and the like. In addition, the libraries 1010 can include API libraries 1024 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1010 can also include a wide variety of other libraries 1028 to provide many other APIs to the applications 1006.

The frameworks 1008 provide a high-level common infrastructure that is used by the applications 1006. For example, the frameworks 1008 provide various graphical user interface (GUI) functions, high-level resource management, and high-level location services. The frameworks 1008 can provide a broad spectrum of other APIs that can be used by the applications 1006, some of which may be specific to a particular operating system or platform.

In an example, the applications 1006 may include a home application 1036, a contacts application 1030, a browser application 1032, a book reader application 1034, a location application 1042, a media application 1044, a messaging application 1046, a game application 1048, and a broad assortment of other applications such as a third-party application 1040. The applications 1006 are programs that execute functions defined in the programs. Various programming languages can be employed to create one or more of the applications 1006, structured in a variety of manners, such as object-oriented programming languages (e.g., Objective-C, Java, or C++) or procedural programming languages (e.g., C or assembly language). In a specific example, the third-party application 1040 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1040 can invoke the API calls 1050 provided by the operating system 1012 to facilitate functionality described herein.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” “includes,” “including,” or any other variation thereof, are intended to cover a non-exclusive inclusion, such that a process, method, article, or apparatus that comprises or includes a list of elements or steps does not include only those elements or steps but may include other elements or steps not expressly listed or inherent to such process, method, article, or apparatus. An element preceded by “a” or “an” does not, without further constraints, preclude the existence of additional identical elements in the process, method, article, or apparatus that comprises the element.

Unless otherwise stated, any and all measurements, values, ratings, positions, magnitudes, sizes, and other specifications that are set forth in this specification, including in the claims that follow, are approximate, not exact. Such amounts are intended to have a reasonable range that is consistent with the functions to which they relate and with what is customary in the art to which they pertain. For example, unless expressly stated otherwise, a parameter value or the like, whether or not qualified by a term of degree (e.g., approximate, substantially or about), may vary by as much as ±10% from the recited amount.

The examples illustrated herein are described in sufficient detail to enable those skilled in the art to practice the teachings disclosed. Other examples may be used and derived therefrom, such that structural and logical substitutions and changes may be made without departing from the scope of this disclosure. The Detailed Description, therefore, is not to be taken in a limiting sense, and the scope of various examples is defined only by the appended claims, along with the full range of equivalents to which such claims are entitled.

What is claimed is:

1. A computer-implemented encryption method for a lightweight cryptography system comprising:
receiving a plain message comprising a plurality of blocks; and
determining a number of rounds of encryption;
wherein if the number of rounds is not completed, encrypting the plurality of the blocks, comprising:
dividing the plurality of blocks into a reference part and a target part;
performing a first function on the target part, wherein at least one parameter of the first function is based on the reference part;
performing a second function on the plurality of the blocks, wherein the second function is a self-inverse function; and
shifting all blocks of the plurality of blocks to one direction,
wherein the blocks at one end of the plurality of blocks to which direction the plurality of blocks are shifted are added at another end of the plurality of blocks forming a new order among the plurality of blocks, and
wherein the shifted blocks and the added blocks are combined in the new order for a next round of encryption.

2. The computer-implemented encryption method of claim 1, wherein the first function is a self-rotation of each of the blocks of the target part.

3. The computer-implemented encryption method of claim 1, wherein the second function is an XOR function.

4. The computer-implemented encryption method of claim 3, wherein the XOR function uses a key.

5. The computer-implemented encryption method of claim 4, wherein the key is generated by choosing a number contained in a KEY POOL based on a random number.

6. The computer-implemented encryption method of claim 4, wherein the encryption is configured to be decrypted using the key.

7. The computer-implemented encryption method of claim 1, wherein the number of rounds of blocks is determined by the number of blocks of the plain message.

8. A computing system for an encryption method for a lightweight cryptography system comprising, comprising:
one or more processors;
a memory coupled to the one or more processors, the memory including instruction that, when executed by the one or more processors, cause the one or more processors to perform functions including:
receiving a plain message comprising a plurality of blocks; and
determining a number of rounds of encryption;
wherein if the number of rounds is not completed, encrypting the plurality of the blocks, comprising:
dividing the plurality of blocks into a reference part and a target part;
performing a first function on the target part, wherein at least one parameter of the first function is based on the reference part;
performing a second function on the plurality of the blocks, wherein the second function is a self-inverse function; and
shifting all blocks of the plurality of blocks to one direction,
wherein the blocks at one end of the plurality of blocks to which direction the plurality of blocks are shifted are added at another end of the plurality of blocks forming a new order among the plurality of blocks, and
wherein the shifted blocks and the added blocks are combined in the new order for a next round of encryption.

9. The computing system of claim 8, wherein the first function is a self-rotation of each of the blocks of the target part.

10. The computing system of claim 8, wherein the second function is an XOR function.

11. The computing system of claim 10, wherein the XOR function uses a key.

12. The computing system of claim 11, wherein the key is generated by choosing a number contained in a KEY POOL based on a random number.

13. The computing system of claim 11, wherein the encryption is configured to be decrypted using the key.

14. The computing system of claim 8, wherein the number of rounds of blocks is determined by the number of blocks of the plain message.

15. A non-transitory computer-readable medium with instructions stored thereon, wherein the medium is configured to be incorporated in an encryption method for a lightweight cryptography system, that when executed by a processor, perform the steps comprising:
receiving a plain message comprising a plurality of blocks; and
determining a number of rounds of encryption;
wherein if the number of rounds is not completed, encrypting the plurality of the blocks, comprising:
dividing the plurality of blocks into a reference part and a target part;
performing a first function on the target part, wherein at least one parameter of the first function is based on the reference part;
performing a second function on the plurality of the blocks, wherein the second function is a self-inverse function; and
shifting all blocks of the plurality of blocks to one direction,
wherein the blocks at one end of the plurality of blocks to which direction the plurality of blocks are shifted are added at another end of the plurality of blocks forming a new order among the plurality of blocks, and
wherein the shifted blocks and the added blocks are combined in the new order for a next round of encryption.

16. The non-transitory computer-readable medium of claim 15, wherein the first function is a self-rotation of each of the blocks of the target part.

17. The non-transitory computer-readable medium of claim 15, wherein the second function is an XOR function.

18. The non-transitory computer-readable medium of claim 17, wherein the XOR function uses a key.

19. The non-transitory computer-readable medium of claim 18, wherein the key is generated by choosing a number contained in a KEY POOL based on a random number and wherein the encryption is configured to be decrypted using the key.

20. The non-transitory computer-readable medium of claim 19, wherein the number of rounds of blocks is determined by the number of blocks of the plain message.
